(19) United States
(12) Patent Application Publication
(10) Pub. No.: US 2026/0140747 A1
(43) Pub. Date: May 21, 2026

(54) IN-VEHICLE INFOTAINMENT SYSTEM, A CONTROL METHOD THEREOF AND A CORRESPONDING VEHICLE

(71) Applicant: Ford Global Technologies, LLC, Dearborn, MI (US)

(72) Inventors: Shenbin Zhao, Shanghai (CN); Guangyu Wang, Shanghai (CN); Yi Gong, Shanghai (CN)

(73) Assignee: Ford Global Technologies, LLC, Dearborn, MI (US)

(21) Appl. No.: 18/949,685

(22) Filed: Nov. 15, 2024

(30) Foreign Application Priority Data
Nov. 17, 2023 (CN) 202311544777X

(51) Int. Cl. G06F 9/451; B60K 35/28; B60K 35/29

(52) U.S. Cl. CPC G06F 9/451; B60K 35/28; B60K 35/29; B60K 2360/164; B60K 2360/186; B60K 2360/741

(57) ABSTRACT

The present disclosure relates to the field of vehicles, and provides an in-vehicle infotainment system, a control method thereof, and a corresponding vehicle. The in-vehicle infotainment system includes a processor and a memory. The memory stores instructions executable by the processor, that, when executed by the processor, cause the processor to perform steps comprising: in response to a system desktop of the in-vehicle infotainment system being activated, presenting a first state of a first resource; and in response to an application being launched, presenting a second state of the first resource and at least partially overlaying it on an interface of the application. The in-vehicle infotainment system, the control method thereof, and the corresponding vehicle of the present disclosure can provide diversified interaction modes for the in-vehicle infotainment system, improve user experience, and narrow the distance with users, thereby improving user satisfaction.

### CROSS-REFERENCE TO RELATED APPLICATIONS

The present application claims priority to and the benefit of China Application No. 202311544777X, filed on Nov. 17, 2023, which is hereby incorporated by reference herein in its entirety.

### FIELD

The present disclosure generally relates to the field of vehicles, and more specifically, to an in-vehicle infotainment system, a control method thereof, and a corresponding vehicle.

### BACKGROUND

In modern vehicles, drivers typically access vehicle functions, applications, and various data through IVI (in-vehicle infotainment) systems of the vehicles. Different programs included in the in-vehicle infotainment system interact with users through elements such as images and sounds to convey various information to users in real-time. The different programs may interact with the users in different ways.

### SUMMARY

The present disclosure summarizes aspects of the embodiments and should not be used to limit the claims. Other implementations are contemplated in accordance with the techniques described herein, as will be apparent upon examination of the following drawings and detailed description, and such implementations are intended to be within the scope of this application.

The inventors of this application have recognized that there is a need for an in-vehicle infotainment system, a control method thereof, and a corresponding vehicle, which should be able to provide diversified interaction modes for the in-vehicle infotainment system, improve user experience, and further narrow the distance with users, thereby improving user satisfaction.

According to an aspect of the present disclosure, there is provided an in-vehicle infotainment system, comprising a processor and a memory, the memory storing instructions executable by the processor that, when executed by the processor, cause the processor to perform steps comprising:
in response to a system desktop of the in-vehicle infotainment system being activated, presenting a first state of a first resource; and
in response to an application being launched, presenting a second state of the first resource and at least partially overlaying it on an interface of the application.

In an embodiment of the present disclosure, the step of presenting a second state of the first resource comprises:
in response to the application being launched, determining type of the launched application and/or current system records; and
determining the second state based on the determined type and/or the current system records.

In an embodiment of the present disclosure, the type comprises at least one or more of the following: navigation type, shopping type, instant messaging type, social media type, audio type, video type, game type, and tool type.

In an embodiment of the present disclosure, the steps further comprise:
in response to confirming that a user achieves a specified achievement, changing the first state and/or the second state.

In an embodiment of the present disclosure, the step of confirming that a user achieves a specified achievement comprises:
receiving an event achievement instruction that informs a user/vehicle of the completion of a specified event and/or identifying that the user/vehicle achieves the specified achievement based on system records.

In an embodiment of the present disclosure, the step of changing the first state and/or the second state comprises:
providing one or more of the following to the first state and/or the second state of the first resource: changing digital accessories, changing overall or local colors, and/or changing overall or local shapes.

In an embodiment of the present disclosure, the steps further comprise:
in response to detecting a second vehicle within a preset distance, changing the first state or the second state, wherein the second vehicle is included within a designated group range.

In an embodiment of the present disclosure, the steps further comprise:
in response to detecting a change in vehicle action, changing the first state or the second state.

In an embodiment of the present disclosure, the change in vehicle action include at least one or more of the following: change in vehicle speed/acceleration, change in vehicle direction, change in slope where the vehicle is located, change in vehicle lighting system, change in vehicle HVAC system, change in vehicle seat system, change in vehicle comfort system, change in window/sunroof position, change in vehicle wiper system, and vehicle starting/parking.

In an embodiment of the present disclosure, the steps further comprise:
in response to receiving a notification signal indicating that the application is running in a backstage, changing the first state or the second state.

In an embodiment of the present disclosure, the notification signal indicating that the application is running in the backstage includes at least one or more of the following: preset location markers-based GPS positioning notification signal, schedule-based time notification signal, incoming call signal, weather change signal, forward traffic congestion signal, and disaster warning signal.

In an embodiment of the present disclosure, the step of presenting a first state of a first resource comprises:
presenting the first state of the first resource in a floating manner that does not completely obscure the application.

In an embodiment of the present disclosure, the step of determining the second state based on the determined type and/or the current system records comprises:
adding corresponding digital accessories or assigning image changes or action changes to the first state of the first resource based on the determined type and/or the current system records to generate the second state.

In an embodiment of the present disclosure, the steps further comprise:
in response to detecting a change in running state of the application, adding different digital accessories or assigning different image changes or action changes to the second state.

In an embodiment of the present disclosure, the steps further comprise:
in response to detecting a preset operation on the first resource in any interface, changing the first state or the second state.

In an embodiment of the present disclosure, the steps further comprise:
detecting user identity characteristics of a current user; and
based on the user identity characteristics, providing the user with state attributes of the first state and/or the second state of the first resource or several state attribute options.

In an embodiment of the present disclosure, the user identity characteristics include at least one or more of the following: age, gender, nationality, and personal preferences; and the state attribute options include at least one or more of the following: digital image style, display area size, activity area range, motion mode, and voice options corresponding to the first state and/or the second state.

According to another aspect of the present disclosure, there is provided a control method for an in-vehicle infotainment system, comprising:
in response to a system desktop being activated, presenting a first state of a first resource; and
in response to an application being launched, presenting a second state of the first resource and at least partially overlaying it on an interface of the application.

According to third aspect of the present disclosure, there is provided a vehicle, comprising an in-vehicle infotainment system and a display for presenting the in-vehicle infotainment system, wherein the in-vehicle infotainment system comprises a processor and a memory, the memory stores instructions executable by the processor, that, when executed by the processor, cause the processor to perform steps comprising:
in response to a system desktop of the in-vehicle infotainment system being activated, presenting a first state of a first resource; and
in response to an application being launched, presenting a second state of the first resource and at least partially overlaying it on an interface of the application.

In an embodiment of the present disclosure, the vehicle further comprises several different types of sensors that are communicably connected to the in-vehicle infotainment system and configured to provide vehicle operation data to the in-vehicle infotainment system.

The general description above and the detailed description below are only illustrative and not limiting of the claimed subject matter.

### BRIEF DESCRIPTION OF THE DRAWINGS

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as is known in the art. Further in the figures, reference numbers refer to like parts throughout the different figures.

FIG. 1 shows a schematic diagram of an embodiment of a vehicle including an in-vehicle infotainment system according to the present disclosure;

FIG. 2 shows a system architecture schematic diagram of an embodiment of the in-vehicle infotainment system according to the present disclosure;

FIG. 3 shows a system flowchart of an embodiment of the in-vehicle infotainment system according to the present disclosure;

FIG. 4 shows a system flowchart of an embodiment of the in-vehicle infotainment system according to the present disclosure;

FIG. 5 shows a system flowchart of an embodiment of the in-vehicle infotainment system according to the present disclosure;

FIG. 6 shows a system flowchart of an embodiment of the in-vehicle infotainment system according to the present disclosure;

FIG. 7 shows a system flowchart of an embodiment of the in-vehicle infotainment system according to the present disclosure;

FIG. 8 shows a system flowchart of an embodiment of the in-vehicle infotainment system according to the present disclosure;

FIG. 9 shows a system flowchart of an embodiment of the in-vehicle infotainment system according to the present disclosure;

FIG. 10 shows a system flowchart of an embodiment of the in-vehicle infotainment system according to the present disclosure;

FIG. 11 shows a system flowchart of an embodiment of the in-vehicle infotainment system according to the present disclosure;

FIG. 12 shows a system flowchart of an embodiment of the in-vehicle infotainment system according to the present disclosure;

FIG. 13 shows a flowchart of an embodiment of a control method for an in-vehicle infotainment system according to the present disclosure;

FIG. 14 shows a schematic diagram of an embodiment of the in-vehicle infotainment system according to the present disclosure displaying a first state; and

FIG. 15 shows a schematic diagram of an embodiment of the in-vehicle infotainment system according to the present disclosure displaying a second state.

### DETAILED DESCRIPTION

Embodiments of the present disclosure are described below. However, the disclosed embodiments are only examples, and other embodiments may take various alternative forms. Drawings are not necessarily drawn to scale; and some functions may be exaggerated or minimized to show details of specific components. Therefore, the specific structural and functional details disclosed herein should not be interpreted as restrictive, but merely as a representative basis for teaching those skilled in the art to use the present disclosure in various ways. As will be understood by those of ordinary skill in the art, various features shown and described with reference to any one of the drawings may be combined with features shown in one or more other drawings to produce embodiments which is not explicitly shown or described. The combination of the features shown provides a representative embodiment for a typical application. However, various combinations and modifications of features consistent with the teachings of the present disclosure may be expected for certain specific applications or embodiments.

In this application document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

As mentioned in the background above, the inventors have realized that although the different programs of the existing in-vehicle infotainment systems may interact with the users in different ways, the presence of the in-vehicle infotainment system itself is not prominent in this process, the system itself lacks a more intuitive interaction channel with the users and cannot provide a better user experience. Therefore, there is still greater room for improvement in providing more diverse interaction modes for the in-vehicle infotainment systems, further enhancing user experience, and narrowing the distance with the users. Based on the problems and room for improvement in the existing technology, the inventors of the present application provide an in-vehicle infotainment entertainment system, a control method thereof, and a corresponding vehicle in one or more embodiments, which is believed to be able to solve one or more problems in the existing technology including the above-mentioned problems.

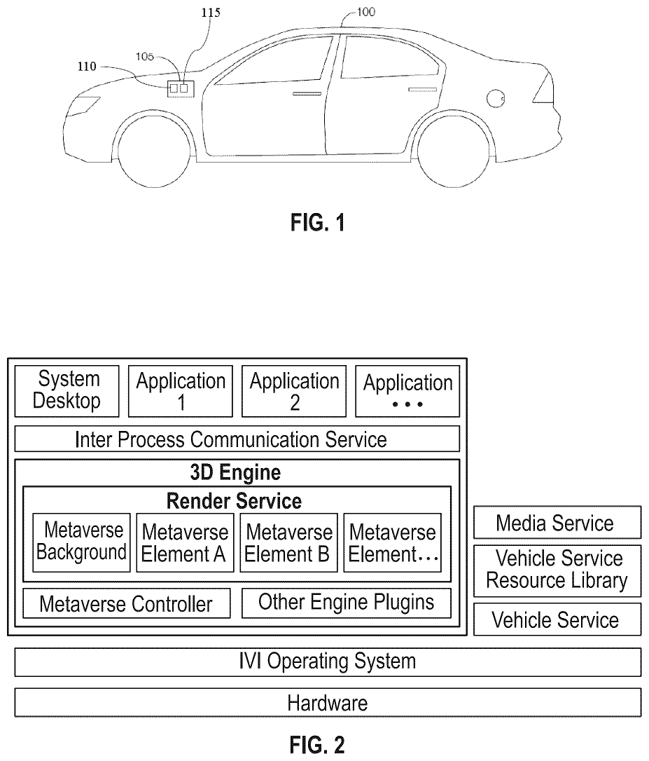

Firstly, FIG. 1 shows a schematic diagram of an embodiment of a vehicle 100 including an in-vehicle infotainment system according to the present disclosure. It should be understood that in the context of the present disclosure, the vehicle 100 implementing the present disclosure may refer to any means of transportation, including but not limited to fossil fuel vehicles, electric vehicles (such as plug-in hybrid electric vehicles (PHEVs), fully hybrid electric vehicles (FHEVs), mild hybrid electric vehicles (MHEVs), or battery electric vehicles (BEVs), etc.), and may even include ships, aircrafts, and the like. The vehicle 100 may include components related to maneuverability, such as engine, electric motor, transmission, suspension, driveshaft, and/or wheels. The vehicle 100 can be non-autonomous, semi-autonomous (for example, some conventional motion functions are autonomously controlled by the vehicle), or autonomous (for example, motion functions are autonomously controlled by the vehicle without direct user input).

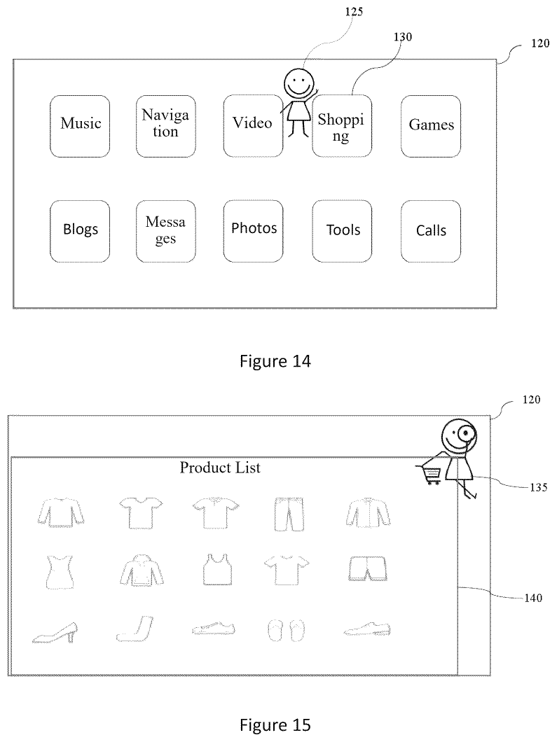

Referring to FIGS. 1 to 3 and referring to FIGS. 14 and 15, according to an aspect of the present disclosure, there is proposed an in-vehicle infotainment system 105, which may include a processor 110 and a memory 115. The memory 115 stores instructions executable by the processor, that, when executed by the processor 110, cause the processor to perform steps comprising: in response to a system desktop 120 of the in-vehicle infotainment system 105 being activated, presenting a first state 125 of a first resource; and in response to an application 130 being launched, presenting a second state 135 of the first resource and at least partially overlaying it on an interface 140 of the application 130.

In the context of the present disclosure, as understood by those skilled in the art, the in-vehicle infotainment system 105 may include various hardware devices such as the processor 110, the memory 115, a positioning device, a communication device, a human-machine interface, etc., and can communicate with various vehicle components and sensors through a vehicle network to transmit data to or from the in-vehicle infotainment system 105 (or its components). The vehicle components may include, but are not limited to, vehicle power transmission system, vehicle lighting system, vehicle HVAC system, vehicle seat system, vehicle comfort system, window/sunroof system, vehicle wiper system, etc. The sensors can include, but are not limited to, vehicle speed/acceleration sensors, cameras, radar sensors, LiDAR sensors, proximity sensors, pressure sensors, and so on. The in-vehicle infotainment system 105 can also use various wireless communication standards or protocols (including but not limited to cellular communication standards, IEEE 802.11 standards, Bluetooth standards, dedicated short-range communication, etc.) to communicate with a cloud and other information sources to transmit various information, such as but not limited to, positioning data of GPS (Global Positioning System), weather data, traffic information data, etc.

Referring to the system architecture shown in FIG. 2, as can be understood by those skilled in the art, the in-vehicle infotainment system 105 can further include an IVI operating system on hardware. The IVI operating system includes interrelated system software programs that manage and control system operations, run hardware and software resources, and provide common services to organize user interactions. The IVI operating system can further include various resources such as conventional vehicle services, vehicle service resource libraries, media services, etc., among which a control unit of a 3D (Three-Dimensional) engine (such as a metaverse controller) can present various visual effects (such as metaverse backgrounds and various elements) on the system desktop 120 through render services. The control unit can further communicate with various applications and system services through other engine plugins and inter process communication services and change the presented interaction state based on the obtained information. The first resource described in the present disclosure can be understood as a digital entity in the digital space constructed by the present disclosure, presented as one of metaverse elements, which can be rendered into specific digital image changes including but not limited to the first state 125, the second state 135, etc., through the 3D engine of the IVI operating system. Through these digital image changes, the first resource can interact with the users based on the information obtained by the IVI operating system, to link the users in the real space with the first resource image in the digital space, thereby improving user experience and further narrowing the distance with the users.

During the startup process of the in-vehicle infotainment system 105, the first resource is presented in the first state 125 along with the startup of the system desktop 120, as shown in the embodiment of FIG. 14. Various states that the first resource may take will accompany the user throughout the process of using the in-vehicle infotainment system 105. As an independent information exchange channel/information presentation interface, the in-vehicle infotainment system 105 can flexibly and diversely convey various information to the user, enhancing the interactive experience of the user.

Expressions such as “presenting” the first state 125, the second state 135, etc. of the first resource used in the present disclosure can not only include visual presentation of static/dynamic images, but also include auditory or tactile presentation such as sound and vibration transmitted through other hardware (such as sound systems, vibration devices, etc.).

Furthermore, a certain state (such as the first state 125 or the second state 135, etc.) is not limited to specific static patterns or images but can also include a series of overall expressions such as images, action patterns, presentation regions, presentation areas, etc. guided by a set of behavioral logic.

In addition, in one or more embodiments, “at least partially overlaying on the interface 140 of the application” may include displaying at least a portion of the corresponding state of the first resource on the interface 140 of the application 130, such as fully or partially displaying on the interface 140 of the application 130. Wherein, the “application” can include a computer program used to complete one or more specific tasks, which can interact with the user and have a visual user interface.

In one embodiment, referring to FIG. 15, a hand of a virtual doll image is resting on a shopping cart icon of a shopping application interface, and a part of the body is also overlaid on it. Additionally, or alternatively, the “overlaying” may also include the image of the second state 135 being partially transparent (such as but not limited to 50% transparency, 70% transparency, etc.) to overlay on the interface 140 of the application 130, thereby avoiding obscuring the information displayed by the application 130. In addition, the image of the second state 135 is not limited to static presentation, and it can optionally float across the entire application interface, such as making actions to guide the route in conjunction with navigation application.

In some embodiments of the present disclosure, the step of presenting the first state 125 of the first resource may include: presenting the first state 125 of the first resource in a floating manner that does not completely obscure the application. As shown in FIG. 14, a doll in the first state 125 obstructs a small portion of a video application icon in the application 130 with its arm and makes a waving action. This feature can convey that the image of the first resource is independent of the appearance of other elements on the system desktop 120, while avoiding interfering with the user operation on the application icon and improving the user experience.

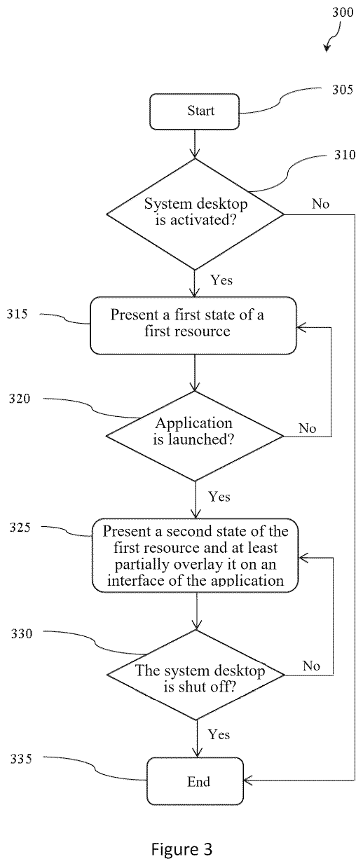

The following further elaborates a process of an embodiment of the in-vehicle information entertainment system 105 in conjunction with FIG. 3. Process 300 starts from block 305, for example but not limited to, after the vehicle is started, and then proceeds to decision block 310, where it is determined whether the system desktop 120 is activated. If the determination result in decision block 310 is negative, then the process 300 proceeds to block 335 and ends there.

If the determination result in decision block 310 is positive, then the process 300 proceeds to block 315, where the first state 125 of the first resource is presented, such as presented the doll image shown in FIG. 14. Of course, different images of the first state 125 can be selected according to user preferences, such as but not limited to dolls, animals, flowers, planets, etc., and different presentation styles can be adopted, such as realistic style, cartoon style, pixelated style, etc.

After block 315, the process 300 proceeds to decision block 320, where it is determined whether the application 130 is launched. The application 130 can be an application that the user chooses to launch (such as but not limited to shopping, navigation, video, etc.) or an application that the system launches based on preset conditions (such as but not limited to pop-up call reminders, schedule reminders, etc.). If the determination result in decision block 320 is negative, then the process 300 returns to block 315, where the first state 125 of the first resource continues to be presented.

If the determination result in decision block 320 is positive, then the process 300 proceeds to block 325, where the second state 135 of the first resource is presented and at least partially overlaid on the interface 140 of the application, as shown in FIG. 15. The change from the first state 125 to the second state 135 can be a local change or an overall change; it can be a corresponding change in posture or action, or even an overall change into another image or another set of behavioral logic.

After block 325, the process 300 proceeds to decision block 330, where it is determined whether the system desktop 120 is shut off. If the determination result in decision block 330 is negative, then the process 300 returns to block 325, where the second state 135 continues to be presented. If the determination result in decision block 330 is positive, then the process 300 proceeds to block 335 and ends there, for example, the in-vehicle infotainment system 105 is turned off.

In some embodiments of the present disclosure, the aforementioned step of presenting the second state of the first resource may include: in response to the application 130 being launched, determining type of the launched application 130 and/or current system records; and determining the second state 135 based on the determined type and/or the current system records.

In several embodiments, the type of the launched application 130 may correspond to the type of system operation currently expected by the user, or the type of interactive operation launched by the system based on preset conditions; and the current system records can include, but are not limited to, records of real space related information such as current time, location, weather, etc. Based on these contents, the specific image of the second state 135 can be determined, which can provide user with a more immersive interactive experience and improve the sense of experience. In one or more embodiments, when the user opens a music playback application on a sunny afternoon, the specific image of the determined second state 135 may be a cartoon image wearing sunglasses and dancing effortlessly to music, which corresponds to the user's real feelings in the real space. The above is only an example and not a limitation.

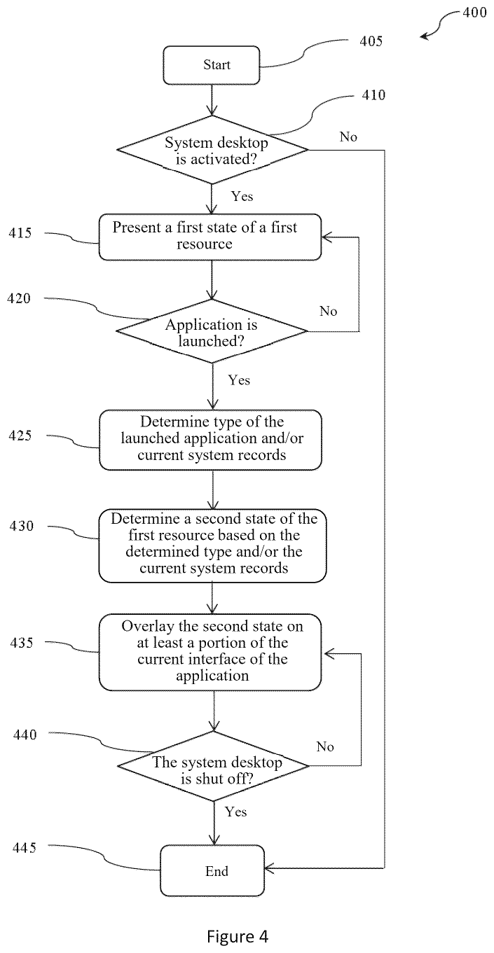

In one embodiment, referring to FIG. 4, a system flowchart of another embodiment of the in-vehicle infotainment system 105 according to the present disclosure is shown. Process 400 starts from block 405, for example but not limited to, after the vehicle is started, and then proceeds to decision block 410, where it is determined whether the system desktop 120 is activated. If the determination result in decision block 410 is negative, then the process 400 proceeds to block 445 and ends there.

If the determination result in decision block 410 is positive, then the process 400 proceeds to block 415, where the first state 125 of the first resource is presented, as the doll image shown in FIG. 14. Similarly, different images can be selected for the first resource based on user preferences, such as but not limited to dolls, animals, flowers, trees, planets, and so on.

After block 415, the process 400 proceeds to decision block 420, where it is determined whether the application 130 is launched. Similarly, the application 130 can be an application that the user chooses to launch (such as but not limited to shopping, navigation, video, etc.) or an application that the system launches based on preset conditions (such as but not limited to pop-up call reminders, schedule reminders, etc.). If the determination result in decision block 420 is negative, then the process 400 returns to block 415, where the first state 125 of the first resource continues to be presented.

If the determination result in decision block 420 is positive, then the process 400 proceeds to block 425, where the type of the launched application 130 and/or the current system records are determined. For example, the type of the application 130 is determined as an audio type application that plays music, and the current time is afternoon, and the weather is clear based on system records.

In several further embodiments, the specific type of the application 130 may include at least one or more of the following: navigation type, shopping type, instant messaging type, social media type, audio type, video type, game type, and tool type. Furthermore, the current system records can include records of various real space related information, including but not limited to the current time, location, weather, etc.

After block 425, the process 400 proceeds to block 430, where the second state 135 of the first resource is determined based on the determined type of the application 130 and/or the current system records. In one or more embodiments, the second state 135 can be determined as an image of dancing while wearing sunglasses based on the previously determined type and/or the current system records.

In one or more embodiments, when the specific type of the launched application 130 is a shopping type application, the specific image of the second state 135 can adopt an image of searching with a magnifying glass, an image of strolling with a shopping bag, and so on; when the specific type of the launched application 130 is a game type application, the specific image of the second state 135 can adopt an image of a cheering audience, an image of a player participating in the game, and so on; and when the specific type of the launched application 130 is a social media type application, the specific image of the second state 135 can adopt a focused image of browsing information, a communicative image of strolling and chatting, and so on. The above is only an example and not a limitation. Meanwhile, the corresponding images can be further adjusted based on the current system records, such as weather, location, current time, and so on. Through various image changes, the user can be provided with a more immersive experience, narrowing the distance between the real space and the digital space in terms of sensation.

According to some embodiments of the present disclosure, the step of determining the second state 135 based on the determined type and/or the current system records may include: adding corresponding digital accessories or assigning image changes or action changes to the first state 125 of the first resource based on the determined type and/or the current system records to generate the second state 135. In one or more embodiments, referring to FIG. 14, the first state 125 is a standing and waving doll image. When the specific type of the launched application 130 is a shopping type application, the left hand of the doll image in the first state 125 is added with a magnifying glass for search actions, the right hand is placed on the shopping cart, with legs leisurely crossed to generate the second state 135, as shown in FIG. 15. In this way, the transition between the first state 125 and the second state 135 exhibits better continuity and is more natural. It can be understood that the change in the image/action can be a local change or an overall change; and the digital accessories can be understood as including various decorative accessories or lighting effects, such as but not limited to headphones, magnifying glasses, hats, badges, clothing, shoes, mobile phones, shopping bags, etc., as well as luminous effects, softening effects, floating effects, etc.

After block 430, the process 400 proceeds to block 435, where the determined second state 135 is at least partially overlaid on the interface 140 of the application 130, as shown in FIG. 15.

After block 435, the process 400 proceeds to decision block 440, where it is determined whether the system desktop 120 is shut off. If the determination result in decision block 440 is negative, then the process 400 returns to block 435, where the second state 135 continues to be presented. If the determination result in decision block 440 is positive, then the process 400 proceeds to block 445 and ends there, for example, the in-vehicle infotainment system 105 is turned off.

According to some embodiments of the present disclosure, the steps may further include changing the first state 125 and/or the second state 135 in response to confirming that the user achieves a specified achievement. In this way, when the user achieves the specified achievement (such as driving time, driving mileage, special events, etc.), assigning a certain degree of change, such as local or overall change, to the subsequently presented first state 125 and/or second state 135 can make the user feel rewarded for their efforts and give the first resource a sense of growth in a certain sense, thereby deepening the user experience.

It can be understood that “changing the first state 125 and/or the second state 135” in the present disclosure may include a temporary change, a permanent change to the first state 125 and/or the second state 135, and a change of a preset length of time. In some embodiments of the present disclosure, the step of changing the first state 125 and/or the second state 135 may include providing one or more of the following to the first state 125 and/or the second state 135 of the first resource: changing digital accessories, changing overall or local colors, and/or changing overall or local shapes. In one or more embodiments, when the user achieves an achievement of 1000 hours of driving time, a digital badge of 1000 hours of mileage can be added to the image of the first state 125 and/or the second state 135. In this way, the previous and subsequent images of the first state 125 and/or the second state 135 have better continuity and a sense of growth, which helps to enhance the user experience.

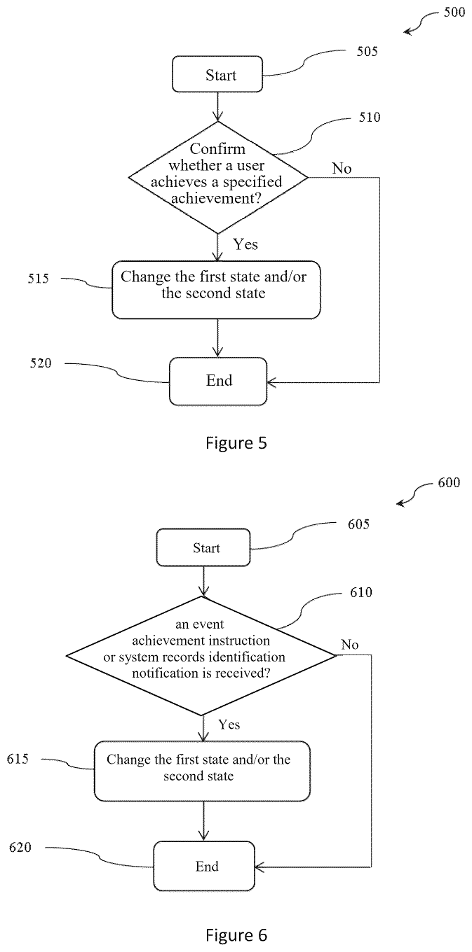

In one embodiment, referring to FIG. 5, a system flowchart of another embodiment of the in-vehicle infotainment system 105 according to the present disclosure is shown.

Process 500 starts from block 505, for example but not limited to, after the in-vehicle infotainment system 105 is activated, and then proceeds to decision block 510, where it is determined whether the user achieves a preset specified achievement, the criteria for which can be one or more. If the determination result in decision block 510 is negative, then the process 500 proceeds to block 520 and ends there.

If the determination result in decision block 510 is positive, for example, the user achieves an achievement of 1000 hours of driving time, then the process 500 proceeds to block 515, where the first state 125 and/or the second state 135 is changed. For example, a digital badge that displays 1000 hours of mileage is added to the image of the first state 125 and/or the second state 135 presented later.

After block 515, the process 500 proceeds to block 520 and ends there, for example, the in-vehicle infotainment system 105 is turned off.

In further embodiments of the present disclosure, the step of confirming that the user achieves a specified achievement may include receiving an event achievement instruction that informs the user/vehicle of the completion of a specified event and/or identifying that the user/vehicle achieves the specified achievement based on system records. Wherein, the event achievement instruction may include, but are not limited to, participating in designated user activities/interactions of manufacturers/service providers or joining designated groups, such as participating in vehicle races organized by the manufacturers or brand car enthusiasts associations, which can further strengthen the connection between vehicle brands and the user and enhance user participation; and the designated achievements achieved by the user/vehicle based on system records can include, but are not limited to, user driving time, vehicle mileage, vehicle driving range, etc., such as current user driving mileage reaching 10000 kilometers, actual vehicle mileage reaching 20000 kilometers, user/vehicle driving in 10 countries/regions, etc. This can provide the user with a certain degree of predictable growth experience.

In one embodiment, referring to FIG. 6, a system flowchart of another embodiment of the in-vehicle infotainment system 105 according to the present disclosure is shown.

Process 600 starts from block 605, for example but not limited to, after the in-vehicle infotainment system 105 is activated, and then proceeds to decision block 610, where it is determined whether an event achievement instruction or system records identification notification indicating that the user achieves the specified achievement is received. If the determination result in decision block 610 is negative, then the process 600 proceeds to block 620 and ends there.

If the determination result in decision block 610 is positive, for example, the notification indicating that the user has participated in a vehicle race organized by the manufacturer is received, then the process 600 proceeds to block 615 where the first state 125 and/or the second state 135 is changed. For example, a commemorative baseball cap with the vehicle or event logo (identification) is worn on the image of the first state 125 and/or the second state 135 presented later.

After block 615, the process 600 proceeds to block 620 and ends there, for example, the in-vehicle infotainment system 105 is turned off.

According to some embodiments of the present disclosure, the aforementioned steps may further include in response to detecting a second vehicle within a preset distance, changing the first state 125 or the second state 135, wherein the second vehicle is included within a designated group range. Wherein, the designated group range can be specified by the user, such as but not limited to vehicles driven by family members, social media/communication software friends, club members, etc. In one or more embodiments, the vehicle 100 and the second vehicle can communicate with the cloud through various wireless communication standards or protocols and transmit real-time GPS positioning information of the vehicle to the cloud. The cloud confirms that the vehicle 100 and the second vehicle are within a preset distance through this information and can send a notification to the vehicle 100 and the second vehicle. For example, when the second vehicle of a friend is found nearby, the currently displayed first state 125 or second state 135 can make a greeting action and display the identity of the other party, while also providing sound effects such as whistling; for another example, in the case where the first state 125 or the second state 135 is a planet image, the effect of mutual gravitational disturbance can be achieved. In this way, rich details can be provided for the interaction between the vehicle users, enhancing the user experience.

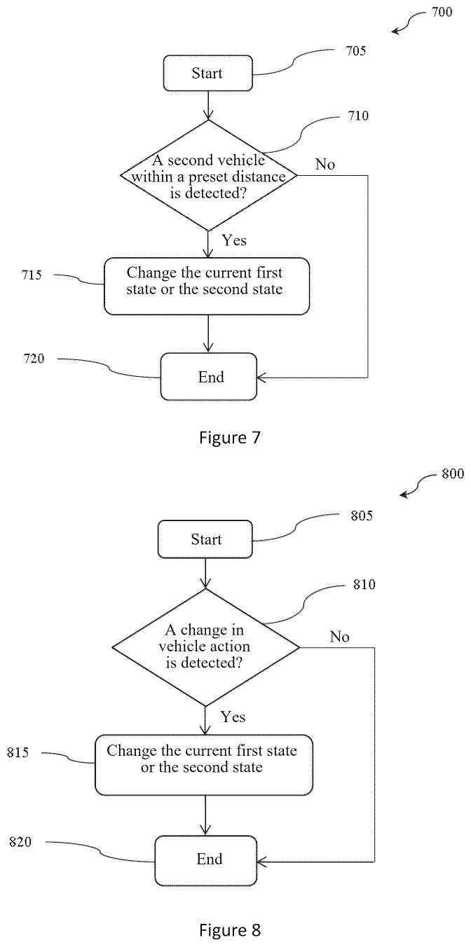

In one embodiment, referring to FIG. 7, a system flowchart of another embodiment of the in-vehicle infotainment system 105 according to the present disclosure is shown.

Process 700 starts from block 705, for example but not limited to, after the in-vehicle infotainment system 105 is activated, and then proceeds to decision block 710, where it is determined whether a second vehicle within a preset distance is detected. If the determination result in decision block 710 is negative, then the process 700 proceeds to block 720 and ends there.

If the determination result in decision block 710 is positive, for example, if the vehicle of the couple is within a 1-kilometer range, then the process 700 proceeds to block 715, where the first state 125 or the second state 135 is changed. For example, greetings, flying kisses, and other actions is made based on the image of the first state 125 and/or the second state 135 currently presented, and the specific image of the other party is displayed.

After block 715, the process 700 proceeds to block 720 and ends there, for example, the in-vehicle infotainment system 105 is turned off.

According to some embodiments of the present disclosure, the aforementioned steps may further include in response to detecting a change in vehicle action, changing the first state 125 or the second state 135. The detection of change in vehicle action can be achieved through communication between the in-vehicle infotainment system 105 and various systems or sensors of the vehicle 100. The changes or variations of the first state 125 or the second state 135 here may correspond to the detected change in vehicle action. For example, when the vehicle 100 is detected to be accelerating, the current presented first state 125 or second state 13 can change accordingly, such as showing actions such as flying hair backwards, lowering the body, and holding down a hat. In this way, the driving actions made by the user can be given visual feedback, further enhancing the driving experience.

In some embodiments, the aforementioned change in vehicle action may include at least one or more of the following: change in vehicle speed/acceleration, change in vehicle direction, change in slope where the vehicle is located, change in vehicle lighting system, change in vehicle HVAC system, change in vehicle seat system, change in vehicle comfort system, change in window/sunroof position, change in vehicle wiper system, and vehicle starting/parking. In one or more embodiments, when the action of automatically spraying glass water onto the windshield is detected, a cartoon dolphin image corresponding to the first state 125 or the second state 135 can spray water accordingly; when the user adjusts seat tilt angle, the image corresponding to the first state 125 or the second state 135 can make an action of leaning back and stretching limb; and when a vehicle window is detected to be open, the image corresponding to the first state 125 or the second state 135 can present the effect of hair being brushed by a gentle breeze. In this way, the changes in the overall vehicle and its various systems/components are linked to the states of the first resource, allowing the action of the user to receive feedback and improving the user experience of the vehicle. It should be pointed out that multiple IVI terminals can be provided in different areas of the vehicle, and the first state 125 or the second state 135 displayed on each IVI terminal can be the same or different. Some changes can only be targeted at devices in the area where the IVI terminal is located, such as response actions to seat position changes, window opening, and HVAC opening.

In one embodiment, referring to FIG. 8, a system flowchart of another embodiment of the in-vehicle infotainment system 105 according to the present disclosure is shown.

Process 800 starts from block 805, for example but not limited to, after the in-vehicle infotainment system 105 is activated, and then proceeds to decision block 810, where it is determined whether a change in vehicle action is detected. If the determination result in decision block 810 is negative, then the process 800 proceeds to block 820 and ends there.

If the determination result in decision block 810 is positive, such as the action of automatically spraying glass water onto the windshield is detected, then the process 800 proceeds to block 815, where the first state 125 or the second state 135 is changed. For example, a spray action can be made by the dolphin image in the first state 125 and/or the second state 135 currently presented.

After block 815, the process 800 proceeds to block 820 and ends there, for example, the in-vehicle infotainment system 105 is turned off.

In some embodiments of the present disclosure, the aforementioned steps may further include; in response to receiving a notification signal indicating that the application is running backstage, changing the first state 125 or the second state 135. For example, when GPS positioning signal notifies that the destination is about to be reached, the image of the first state 125 or the second state 135 can be changed to make it perform closing dance moves or relax limbs; when the GPS positioning signal indicate passing near landmark buildings, the image of the first state 125 or the second state 135 can be changed to create a visual effect of strolling near miniature landmarks, such as strolling past the Eiffel Tower; and when the weather signal indicates that it is about to rain ahead, an umbrella prop can be attached to the image of the first state 125 or the second state 135. In this way, the existence or changes in the real space are linked to the images in the digital space, further improving the user experience.

In several further embodiments of the present disclosure, the aforementioned notification signal indicating that the application is running in the backstage may include at least one or more of the following: preset location markers-based GPS positioning notification signal, such as landmarks, event venues, set POIs (points of interest), destinations, etc.; schedule-based time notification signal, such as preset anniversaries, birthdays, exercise times, etc.; incoming call signal, such as incoming calls; weather change signal, including upcoming weather changes ahead of vehicle travel; forward traffic congestion signal, such as temporary construction, reminders for detours, etc.; and disaster warning signal, such as sudden hail, tornadoes, etc. This enriches the information transmission channels that convey changes in real space through changes in digital spatial image, giving the users a deeper immersive experience.

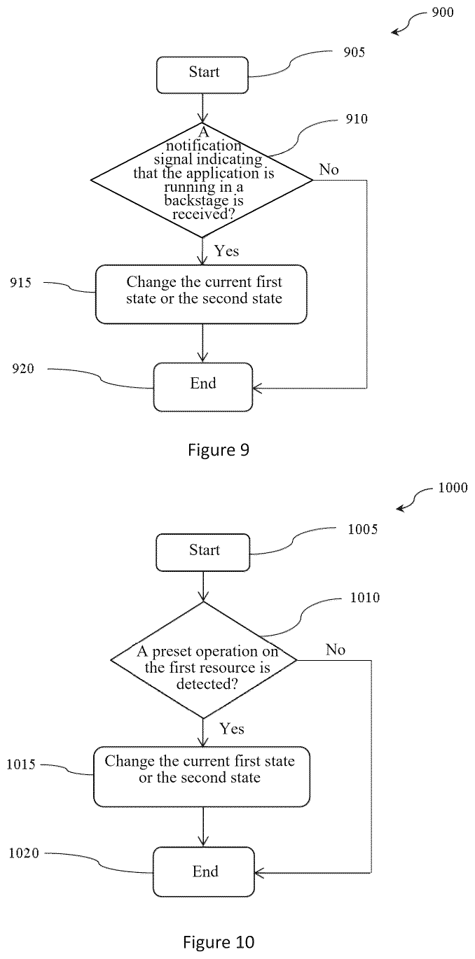

In one embodiment, referring to FIG. 9, a system flowchart of another embodiment of the in-vehicle infotainment system 105 according to the present disclosure is shown.

Process 900 starts from block 905, for example but not limited to after the in-vehicle infotainment system 105 is activated, and then proceeds to decision block 910, where it is determined whether a notification signal indicating that the application is running in the backstage is received. If the determination result in decision block 910 is negative, then process 900 proceeds to block 920 and ends there.

If the determination result in decision block 910 is positive, for example, a notification signal indicating that rainfall has occurred on the driving path ahead of the vehicle is received, then the process 900 proceeds to block 915, where the first state 125 or the second state 135 is changed. For example, an action of unfolding an umbrella to cover the rain is made by the image of the first state 125 and/or the second state 135 currently presented.

After block 915, the process 900 proceeds to block 920 and ends there, for example, the in-vehicle infotainment system 105 is turned off.

According to some embodiments of the present disclosure, the aforementioned steps may further include in response to detecting a preset operation on the first resource in any interface, changing the first state 125 or the second state 135. Wherein, the preset operation can include any pre-set operational action, such as clicking, voice calling, etc. In one or more embodiments, if the user clicks on the first state 125 or the second state 135 of the first resource, the first state 125 or the second state 135 may undergo overall or local changes to make a response action, such as questioning, laughing, greeting, etc. In some embodiments, this operation can also call an artificial intelligence model for voice Q&A communication. This can make the first state 125 or the second state 135 of the first resource more anthropomorphic, enhancing the user experience.

In one embodiment, referring to FIG. 10, a system flowchart of another embodiment of the in-vehicle infotainment system 105 according to the present disclosure is shown.

Process 1000 starts from block 1005, such as but not limited to after the in-vehicle infotainment system 105 is activated, and then proceeds to decision block 1010, where it is determined whether the preset operation on the first resource is detected. If the determination result in decision block 1010 is negative, then the process 1000 proceeds to block 1020 and ends there.

If the determination result in decision block 1010 is positive, such as a click on the first state 125 is detected, then the process 1000 proceeds to block 1015, where the corresponding first state 125 is changed accordingly. For example, a questioning expression is made by the image of the first state 125 currently presented.

After block 1015, the process 1000 proceeds to block 1020 and ends there, for example, the in-vehicle infotainment system 105 is turned off.

In some embodiments of the present disclosure, the aforementioned steps may further include in response to detecting a change in running state of the application 130, adding different digital accessories or assigning different image changes or action changes to the second state 135. The aforementioned description of change in the running state of the application 130 can correspond to any parameter/state change that occur in the application 130, such as but not limited to application interface transition, application shutdown, and so on. In one or more embodiments, if the music style being played by the application 130 switches from pop music to country music, the image of the second state 135 can switch from rhythmic dancing to picking up a folk guitar and wearing a cowboy hat; if the application 130 transitions from searching for videos to playing videos, the image of the second state 135 can switch from a magnifying glass search posture to a seated viewing posture, while also increasing display transparency to reduce presence and avoid interfering with video playback; and if the current state of the application 130 transitions to off state, the second state 135 can be assigned an image change to return to the first state 125. In this way, the interaction with the users is further enriched, providing a more immersive experience.

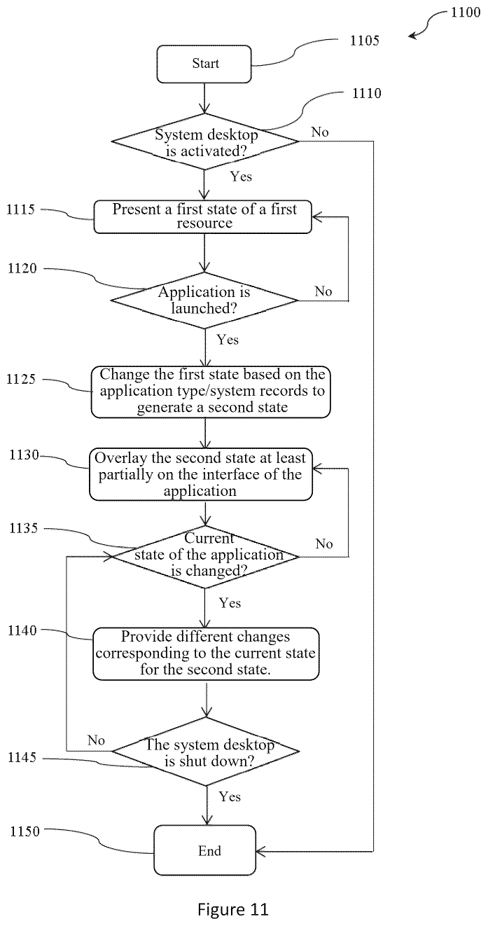

In one embodiment, referring to FIG. 11, a system flowchart of another embodiment of the in-vehicle infotainment system 105 according to the present disclosure is shown.

Process 1100 starts from block 1105, for example but not limited to, after the start of the vehicle 100, and then proceeds to decision block 1110, where it is determined whether the system desktop 120 is activated. If the determination result in decision block 1110 is negative, then the process 1100 proceeds to block 1150 and ends there.

If the determination result in decision block 1110 is positive, then the process 1100 proceeds to block 1115, where the first state 125 of the first resource is presented, such as presented as a doll image as shown in FIG. 14. Similarly, different images of the first state 125 can be selected according to user preferences, such as but not limited to dolls, animals, flowers, trees, planets, and so on.

After block 1115, the process 1100 proceeds to decision block 1120, where it is determined whether the application 130 is launched. If the determination result in decision block 1120 is negative, then the process 1100 returns to block 1115, where the first state 125 of the first resource continues to be presented.

If the determination result in decision block 1120 is positive, then the process 1100 proceeds to block 1125, where the first state 125 is changed based on the type of the application/system records to generate the second state 135. For example, when the type of the application 130 is determined to be audio type for playing music, a guitar is added to the arms of the doll in the first state 125 to generate the corresponding second state 135.

After block 1125, the process 1100 proceeds to block 1130, where the generated second state 135 is at least partially overlaid on the interface 140 of the application 130. For example, the doll holding a guitar generated in block 1125 is overlaid on the playback interface and displayed as sitting with one leg down.

After block 1130, the process 1100 proceeds to decision block 1135, where it is determined whether the current state of the application is changed. If the determination result in decision block 1135 is negative, then the process 1100 returns to block 1130, where the second state 135 of the first resource continues to be presented.

If the determination result in decision block 1135 is positive, then the process 1100 proceeds to block 1140, where different changes corresponding to the current state of the application 130 are provided for the second state 135. For example, if the type of the played music is changed from country to rock, a folk guitar held by the doll in the previous state can be switched to an electric guitar. In some embodiments, if the current state of the application 130 changes to off state, the second state 135 can be transitioned back to the first state 125.

After block 1140, the process 1100 proceeds to decision block 1145, where it is determined whether the system desktop 120 is shut down. If the determination result in decision block 1145 is negative, then the process 1100 returns to block 1135, where whether the current state of the application is changed is continuously monitored. If the determination result in decision block 1145 is positive, then the process 1100 proceeds to block 1150 and ends there, for example, the in-vehicle infotainment system 105 is turned off.

In some embodiments of the present disclosure, the aforementioned steps may further include detecting user identity characteristics of a current user; and based on the user identity characteristics, providing the user with state attributes of the first state 125 and/or the second state 135 of the first resource or several state attribute options for selection. The detection of user identity can be achieved, for example but not limited to, by remote keys, paired mobile phones, etc. The state attributes may include any selectable visual, auditory, or tactile attributes of the first state 125 and/or the second state 135. In daily life, many household vehicles may have more than one user, providing different users with a way to quickly switch or set the first state 125 and/or second state 135 of the first resource, for example, based on their pre-selection or preference, thereby quickly providing the users with their preferred interactive image, which improves usability. The provided status attributes can be pre-set/pre-stored avatars directly provided based on the user identity characteristics, or several options provided for the users to quickly set.

In several further embodiments, the user identity characteristics may include at least one or more of the following: age, gender, nationality, and personal preferences. The state attribute options may include at least one or more of the following: digital image style, display area size, active area range, motion mode, and voice options corresponding to the first and/or second states. For example, outgoing young users may tend to prefer more active digital images, larger display areas, or larger activity ranges. In this way, the users are provided with a channel to quickly set interactive images based on their own characteristics and cultural backgrounds, meeting the diverse needs of the different users.

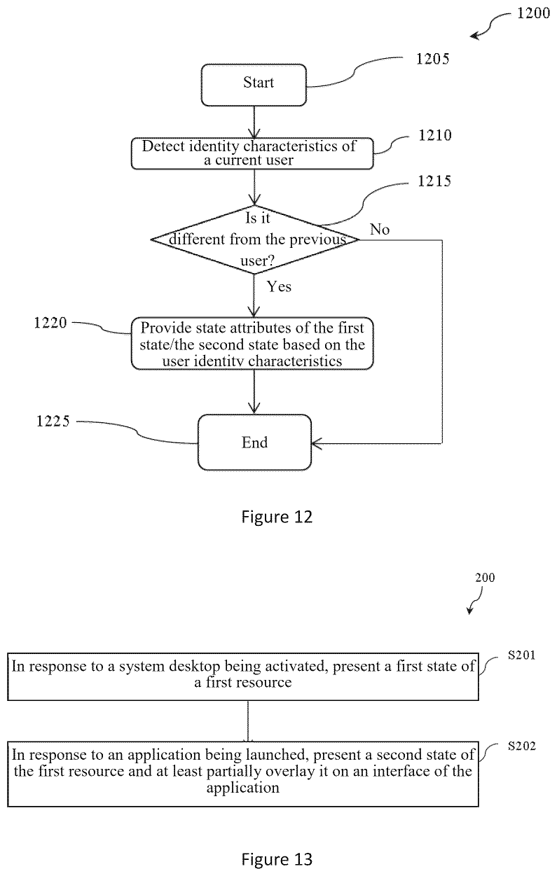

In one embodiment, referring to FIG. 12, a system flowchart of another embodiment of the in-vehicle infotainment system 105 according to the present disclosure is shown.

Process 1200 starts from block 1205, for example but not limited to, after the in-vehicle infotainment system 105 is activated, and then proceeds to block 1210, where current user identity characteristics are detected.

Subsequently, the process 1200 proceeds to decision block 1215, where it is determined whether the user is different from the previous user based on the current user identity characteristics. If the determination result in decision block 1215 is negative, then the process 1200 proceeds to block 1225 and ends there.

If the determination result in decision block 1215 is positive, then the process 1200 proceeds to block 1220, where state attributes of the first state 125 and/or the second state 135 is provided based on the user identity characteristics. For example, the user is directly provided with previously used or pre-stored status attributes or is provided with a series of status attribute options such as digital image, display area, and activity range.

After block 1220, the process 1200 proceeds to block 1225 and ends there, for example, the in-vehicle infotainment system 105 is turned off.

According to another aspect of the present disclosure, with reference to FIG. 13, there is also provided a control method 200 for an in-vehicle infotainment system, comprising:
S201: in response to the system desktop 120 being activated, presenting the first state 125 of the first resource; and
S202: in response to the application 130 being launched, presenting the second state 135 of the first resource and at least partially overlaying it on the interface 140 of the application 130.

All embodiments, features, and advantages described above for the in-vehicle infotainment system 105 according to the present disclosure are equally applicable to the control method 200 of the in-vehicle infotainment system according to the present disclosure, if they do not conflict with each other. All embodiments and their variations applied to the in-vehicle infotainment system 105 described above can be directly applied to the control method according to the present disclosure, and directly combined with it. For the sake of brevity in this disclosure, it will not be repeated here.

According to yet another aspect of the present disclosure, with reference to FIG. 1, there is also provided a vehicle 100 comprising the in-vehicle infotainment system 105 and a display (not shown) for presenting the in-vehicle infotainment system 105. The in-vehicle infotainment system 105 may include a processor 110 and a memory 115. The memory 115 stores processor executable instructions, that, when executed by the processor 110, cause the processor to perform steps comprising: in response to the system desktop 120 being activated, presenting the first state 125 of the first resource; and in response to the application 130 being launched, presenting the second state 135 of the first resource and at least partially overlay it on the interface 140 of the application 130. It should be understood that depending on the structure of the vehicle, the display for presenting the in-vehicle information entertainment system 105 can be provided at different positions or any number of positions on the vehicle 100, and any known or potentially developed display technology can be used, such as but not limited to LED (Light Emitting Diode) display, OLED (Organic Light Emitting Diode) display, and so on.

According to some embodiments of the present disclosure, the vehicle 100 may also include several different types of sensors, which are communicably connected to the in-vehicle infotainment system 105 and provide vehicle operation data to the in-vehicle infotainment system 105. The sensors should be broadly understood here, including but not limited to independent sensors such as vehicle speed/acceleration sensors, pitch sensors, yaw sensors, cameras, radar sensors, LiDAR sensors, as well as various information collection devices attached to vehicle lighting system, HVAC system, vehicle seat system, vehicle comfort system, window/sunroof system, wiper system, and any other information source that can be accessed through network connections.

Similarly, all embodiments, features, and advantages described above for the in-vehicle infotainment system 105 according to the present disclosure are equally applicable to the vehicle 100 according to the present disclosure and directly incorporated therein, if they do not conflict with each other. For the sake of brevity in this disclosure, it will not be repeated here.

In summary, compared to existing technologies, the present disclosure proposes an in-vehicle infotainment system, a control method thereof, and a corresponding vehicle, which can provide diversified interaction modes for the in-vehicle infotainment system, improve user experience, and narrow the distance with the users, thereby improving user satisfaction.

Where it is technically possible, the technical features listed in relation to different embodiments can be combined with each other to form further embodiment within the scope of the present disclosure.

In this application, the use of the disjunctive is intended to include the conjunctive. The use of definite or indefinite articles is not intended to indicate cardinality. A reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The term “including” is inclusive and has the same scope as “comprising”.

The above-mentioned embodiments are possible examples of implementations of the present disclosure and are given only for the purpose of enabling those skilled in the art to clearly understand the principles of the invention. It should be understood by those skilled in the art that the above discussion to any embodiment is only illustrative and is not intended to imply that the disclosed scope of the embodiments of the present disclosure (including claims) is limited to these examples. Under the overall concept of the invention, the technical features in the above embodiments or different embodiments can be combined with each other to produce many other their variants in different aspects of embodiments of the invention that is not provided in detailed description for the sake of brevity. Therefore, any omission, modification, equivalent replacement, improvement, etc. made within the spirit and principle of the embodiment of the invention shall be included in the scope of protection claimed by the invention.

1. An in-vehicle infotainment system, comprising a processor and a memory, the memory storing instructions executable by the processor, that, when executed by the processor, cause the processor to perform steps comprising:
in response to a system desktop of the in-vehicle infotainment system being activated, presenting a first state of a first resource; and
in response to an application being launched, presenting a second state of the first resource and at least partially overlaying it on an interface of the application.

2. The in-vehicle infotainment system according to claim 1, wherein the step of presenting a second state of the first resource comprises:
in response to the application being launched, determining a type of the launched application and/or current system records; and
determining the second state based on the determined type and/or the current system records.

3. The in-vehicle infotainment system according to claim 2, wherein the type comprises at least one or more of the following: navigation type, shopping type, instant messaging type, social media type, audio type, video type, game type, or tool type.

4. The in-vehicle infotainment system according to claim 1, wherein the steps further comprise:
in response to confirming that a user achieves a specified achievement, changing the first state and/or the second state.

5. The in-vehicle infotainment system according to claim 4, wherein the step of confirming that a user achieves a specified achievement comprises:
receiving an event achievement instruction that informs a user/vehicle of the completion of a specified event and/or identifying that the user/vehicle achieves the specified achievement based on system records.

6. The in-vehicle infotainment system according to claim 4, wherein the step of changing the first state and/or the second state comprises:
providing one or more of the following to the first state and/or the second state of the first resource: changing digital accessories, changing overall or local colors, and/or changing overall or local shapes.

7. The in-vehicle infotainment system according to claim 1, wherein the steps further comprise:
in response to detecting a second vehicle within a preset distance, changing the first state or the second state, wherein the second vehicle is included within a designated group range.

8. The in-vehicle infotainment system according to claim 1, wherein the steps further comprise:
in response to detecting a change in vehicle action, changing the first state or the second state.

9. The in-vehicle infotainment system according to claim 8, wherein the change in vehicle action includes at least one or more of the following: change in vehicle speed/acceleration, change in vehicle direction, change in slope where the vehicle is located, change in vehicle lighting system, change in vehicle HVAC system, change in vehicle seat system, change in vehicle comfort system, change in window/sunroof position, change in vehicle wiper system, or vehicle starting/parking.

10. The in-vehicle infotainment system according to claim 1, wherein the steps further comprise:
in response to receiving a notification signal indicating that the application is running in a backstage, changing the first state or the second state.

11. The in-vehicle infotainment system according to claim 10, wherein the notification signal indicating that the application is running in the backstage includes at least one or more of the following: preset location markers-based GPS positioning notification signal, schedule-based time notification signal, incoming call signal, weather change signal, forward traffic congestion signal, or disaster warning signal.

12. The in-vehicle infotainment system according to claim 1, wherein the step of presenting a first state of a first resource comprises:
presenting the first state of the first resource in a floating manner that does not completely obscure the application.

13. The in-vehicle infotainment system according to claim 2, wherein the step of determining the second state based on the determined type and/or the current system records comprises:
adding corresponding digital accessories or assigning image changes or action changes to the first state of the first resource based on the determined type and/or the current system records to generate the second state.

14. The in-vehicle infotainment system according to claim 13, wherein the steps further comprise:
in response to detecting a change in running state of the application, adding different digital accessories or assigning different image changes or action changes to the second state.

15. The in-vehicle infotainment system according to claim 1, wherein the steps further comprise:
in response to detecting a preset operation on the first resource in any interface, changing the first state or the second state.

16. The in-vehicle infotainment system according to claim 1, wherein the steps further comprise:
detecting user identity characteristics of a current user; and
based on the user identity characteristics, providing the user with state attributes of the first state and/or the second state of the first resource or several state attribute options.

17. The in-vehicle infotainment system according to claim 16, wherein the user identity characteristics include at least one or more of the following: age, gender, nationality, and personal preferences; and the state attribute options include at least one or more of the following: digital image style, display area size, activity area range, motion mode, or voice options corresponding to the first state and/or the second state.

18. A control method for an in-vehicle infotainment system, comprising:
in response to a system desktop being activated, presenting a first state of a first resource; and
in response to an application being launched, presenting a second state of the first resource and at least partially overlaying it on an interface of the application.

19. A vehicle, comprising an in-vehicle infotainment system and a display for presenting the in-vehicle infotainment system, wherein the in-vehicle infotainment system comprises a processor and a memory, the memory stores instructions executable by the processor, that, when executed by the processor, cause the processor to perform steps comprising:
in response to a system desktop of the in-vehicle infotainment system being activated, presenting a first state of a first resource; and
in response to an application being launched, presenting a second state of the first resource and at least partially overlaying it on an interface of the application.

20. The vehicle according to claim 19, further comprising several different types of sensors that are communicably connected to the in-vehicle infotainment system and configured to provide vehicle operation data to the in-vehicle infotainment system.
